(19) United States
(12) Patent Application Publication
(10) Pub. No.: US 2013/0112444 A1
(43) Pub. Date: May 9, 2013

(54) Tractor Lift Arm Stabilizer

(71) Applicants: J. Phillip Fraley, Winfield, AL (US); John W. Davis, Winfield, AL (US)

(72) Inventors: J. Phillip Fraley, Winfield, AL (US); John W. Davis, Winfield, AL (US)

(21) Appl. No.: 13/663,284

(22) Filed: Oct. 29, 2012

Related U.S. Application Data
(63) Continuation-in-part of application No. 13/024,201, filed on Feb. 9, 2011, now abandoned.
(60) Provisional application No. 61/302,803, filed on Feb. 9, 2010.

(51) Int. Cl. A01B 59/041

(52) U.S. Cl. CPC A01B 59/041
USPC 172/450

(57) ABSTRACT

An apparatus for stabilizing at least two lift arms on a tractor has a center portion disposed below the power take-off of the tractor. A plurality of angled legs connect to and extend downwardly from the lift arms. A space is formed by the angled legs to allow for connection of an implement to the PTO of the tractor.

### CROSS-REFERENCE TO RELATED APPLICATIONS

This application is a continuation-in-part of and claims priority to U.S. Non-provisional patent application Ser. No. 13/024,201, filed on Feb. 9, 2011, the entire contents of which are incorporated by reference. This application claims the benefit of U.S. Provisional Application No. 61/302,803 titled “Tractor Lift Arm Stabilizer,” filed on Feb. 9, 2010, the entire contents of which are herein incorporated by reference.

### BACKGROUND AND SUMMARY OF THE INVENTION

A stabilizer for the lift arms of a tractor is provided. Two lift arms and a center top link make up the three “points” of the tractor's three point hitch. The lift arms are controlled by a hydraulic system of the tractor, which provides lifting and lowering of the lift arms. The three point hitch is used to connect farming implements and other implements to the tractor.

Certain tractor operations and/or implements may cause the lift arms to sway from side to side. A stabilizer as described herein attaches to the lift arms and provides rigidity to keep the lift arms stable and prevent or minimize such side-to-side movement.

In one embodiment, the stabilizer comprises an x-shaped frame comprising four (4) legs rigidly affixed to the lift arms of the tractor. The legs are adjustably connected to a center plate that extends below the drive line and power take-off extending from the tractor. In another embodiment, the stabilizer comprises two angled bars that connect to the left and right lift arms and are joined together beneath the drive line and power take-off.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 is a prior art tractor.

FIG. 2 is a rear perspective view of an exemplary stabilizer in accordance with the present disclosure installed on the lift alms of a tractor.

FIG. 3 is a top plan view of the stabilizer of FIG. 2.

FIG. 4 is a rear plan view of the stabilizer of FIG. 2.

FIG. 5 is a side plan view of the stabilizer of FIG. 2.

FIG. 6a is a front perspective view of an exemplary roller chain bolt in accordance with the present disclosure.

FIG. 6b is a front plan view of the roller chain bolt of FIG. 6a.

FIG. 6c is a side plan view of the roller chain bolt of FIG. 6a.

FIG. 6d is a bottom plan view of the roller chain bolt of FIG. 6a.

FIG. 6e is a top plan view of the roller chain bolt of FIG. 6a.

FIG. 7a is a front perspective view of an exemplary stabilizer leg in accordance with the present disclosure.

FIG. 7b is a front plan view of the stabilizer leg of FIG. 7a.

FIG. 7c is an end view of the stabilizer leg of FIG. 7a.

FIG. 7d is a top view of the stabilizer leg of FIG. 7a.

FIG. 8a is a perspective view of an exemplary center plate in accordance with the present disclosure.

FIG. 8b is a top plan view of the center plate of FIG. 8a.

FIG. 8c is a right side plan view of the center plate of FIG. 8a.

FIG. 8d is a front side plan view of the center plate of FIG. 8a.

FIG. 9a is a side plan view of a tube according to an embodiment of the present disclosure.

FIG. 9b is an end view of the tube of FIG. 9a.

FIG. 10 is a top plan view of a bolt plate according to an embodiment of the present disclosure.

FIG. 11 is a top plan view of a pivot plate according to an embodiment of the present disclosure.

FIG. 12 is a rear perspective view of an alternative embodiment of an exemplary stabilizer in accordance with the present disclosure installed on the lift arms of a tractor.

FIG. 13 is a rear plan view of the stabilizer of FIG. 12.

FIG. 14 depicts a stabilizer according to an alternative embodiment of the present disclosure.

FIG. 15 is a perspective view of the stabilizer of FIG. 14.

FIG. 16 is a rear plan view of the stabilizer of FIG. 14.

FIG. 17 is a top view of the stabilizer of FIG. 14.

FIG. 18 is a top view of the stabilizer of FIG. 14 shown installed on the tractor.

FIG. 19 is a rear view of the stabilizer of FIG. 14.

### DETAILED DESCRIPTION

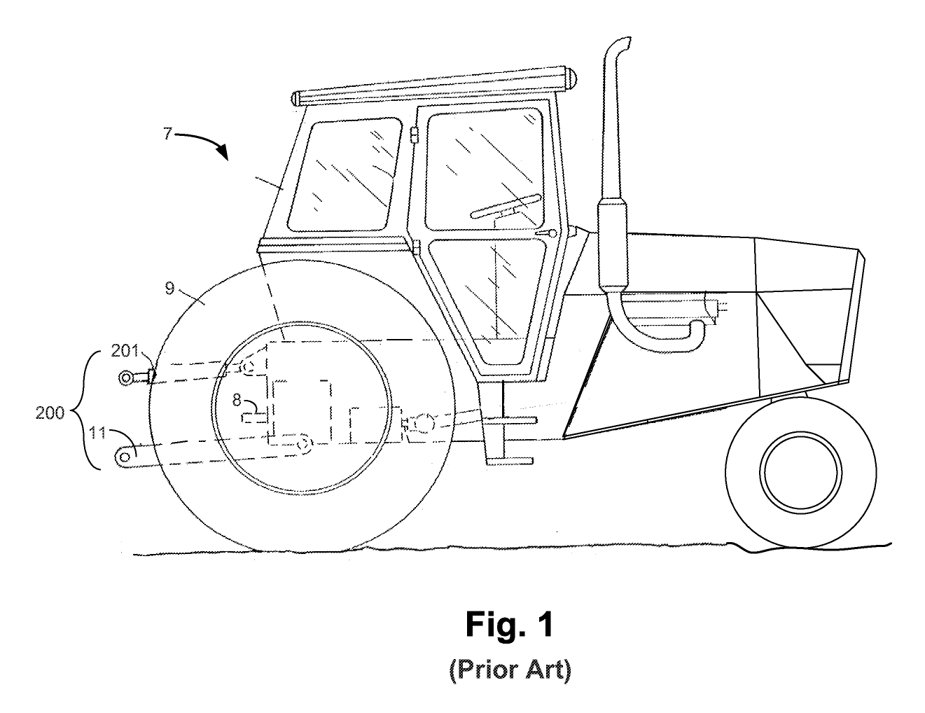

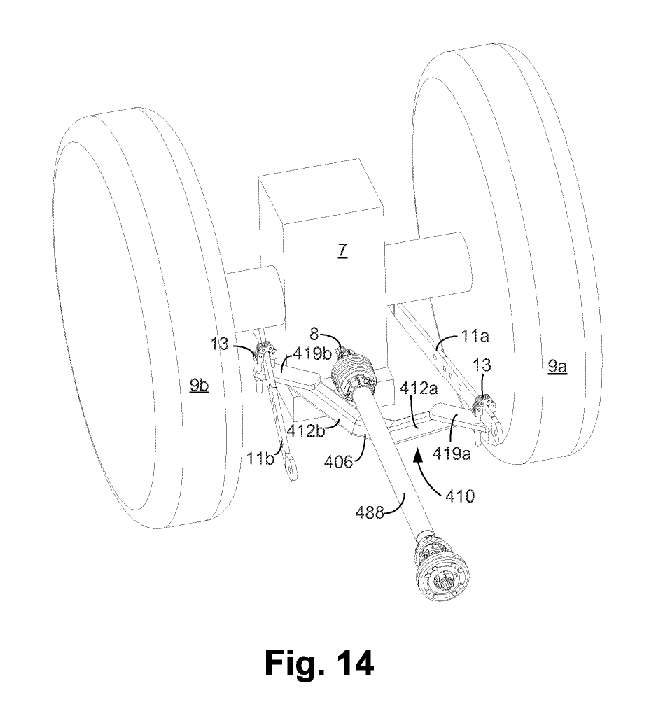

FIG. 1 depicts a prior art tractor 7 comprising a three point hitch 201 that is known in the art. As known by persons of skill in the art, the three point hitch 200 of the tractor 7 comprises the two substantially similar lift arms 11 (only one of which is shown FIG. 14) and a top link 201. The three point hitch 200 is disposed between the rear wheels 9 (only one of which is shown in FIG. 1) of the tractor 7.

A power take-off (PTO) 8 extends from the tractor 7 generally between the rear wheels 9 of the tractor 7. As is known by persons of skill in the art, the PTO 8 is a splined driveshaft on a tractor or truck that is used to provide power, in the form of rotation, to an attachment, such as a farming implement (not shown), or to separate machines. A drive line (not shown) that is known in the art extends between the PTO 8 and the attachment and translates rotation from the PTO to the attachment.

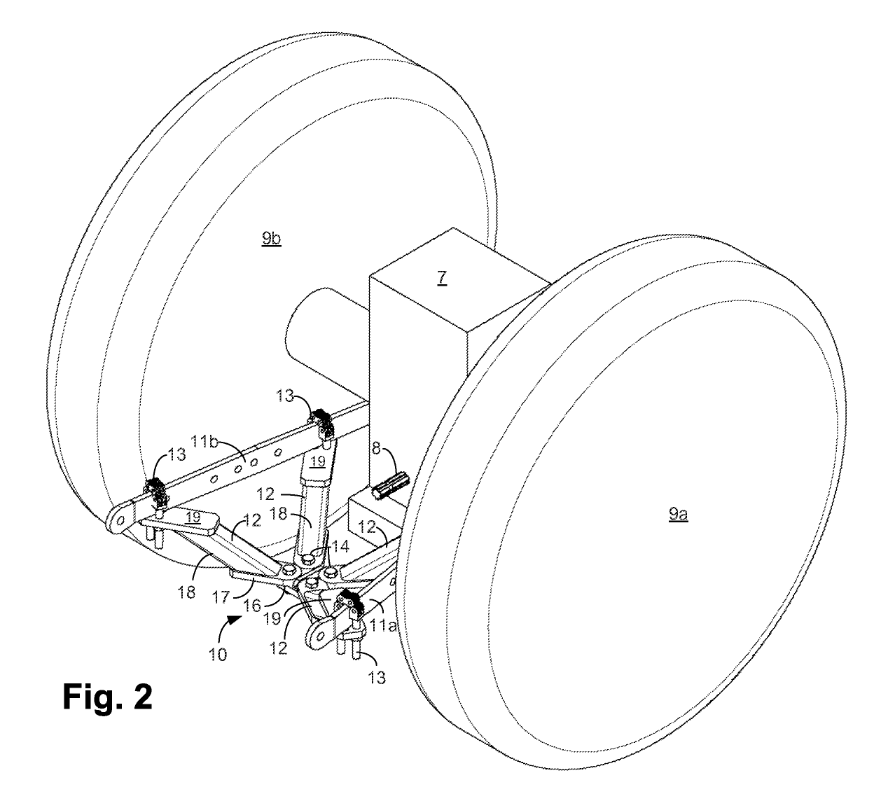

FIG. 2 depicts a stabilizer 10 according to an embodiment of the present disclosure. The stabilizer 10 is installed on the tractor 7 to stabilize the lift arms 11a and 11b. In this regard, the stabilizer 10 adjustably connects to the lift arms 11a and 11b of the tractor 7 without interfering with the PTO 8. Note that in FIG. 2 and subsequent figures, the tractor 7 is illustrated as a three-dimensional box disposed between a right rear wheel 9a and a left rear wheel 9b of the tractor 8. However, the tractor 7 is intended to represent a standard prior art tractor of the type well known in the art, and pictured in exemplary form in FIG. 1.

The stabilizer 10 comprises a plurality of angled legs 12 adjustably connected to a center plate 16 via a plurality of fasteners 14. Each leg 12 comprises a tube 18 extending angularly between a lower pivot plate 17 and an upper bolt plate 19. In one embodiment, the tube 18 is rigidly attached to the lower pivot plate 17 and the upper bolt plate 19, for example via welding. The lower pivot plate 17 of each leg 12 adjustably connects to the center plate 16. In this regard, the legs 12 are adjustable when the fasteners 14, which may be standard bolts, are loose-installed. After the fasteners 14 are tightened, the legs 12 are rigid with respect to one another.

The legs 12 radiate from the center plate 16 in the general shape of an “X.” Notably, the center plate 16 is lower than the PTO 8. In this regard, the stabilizer 10 does not interfere with the operation of a rotating shaft (not shown) that connects to the PTO 8 to power an implement. Further, the legs 12 radiate upward at an angle relative to the center plate 16. Although the illustrated embodiment depicts a stabilizer 10 with four (4) legs 12, in other embodiments there may be more or fewer legs 12.

The upper bolt plate 19 of the leg 12 adjustably connects to the lift arms 11a and 11b via a plurality of roller chain bolts 13. In this regard, each lift arm 11a and 11b is affixed to the bolt plate 19 of two (2) legs 12 at opposed ends of the lift arms 11a and 11b, as shown by the roller chain bolts 13. In one embodiment, the roller chain bolts 13 each comprise a plurality of free-moving links held moveably in position by connectors. Thus, there is some give between the links such that the roller chain bolts 13 do not rigidly retain the lift arms 11a and 11b and can be adjustably connected to the upper bolt plate 19 around the lift arms 11a and 11b.

The roller chain bolts 13 are received by openings (not shown) in the bolt plates 19 of the legs 12 and are secured by nuts (not shown). The roller chain bolts 13 therefore comprise male threads (not shown) to receive the nuts.

FIG. 3 is a top plan view of the stabilizer 10 of FIG. 2 showing legs 12a, 12b, 12c, and 12d radiating from the center plate 16 in the general shape of an “X.” The right forward leg 12a adjustably connects to the right lift arm 11a at a forward end 21 of the lift arm 11a via roller chain bolt 13a. The right rearward leg 12b adjustably connects to the right lift arm 11a at a rearward end 22 of the lift arm 11a via roller chain bolt 13b. The left forward leg 12c adjustably connects to the left lift arm 11b at a forward end 23 of the left lift arm 11b via roller chain bolt 13c. The left rearward leg 12d adjustably connects to the left lift arm 11b at a rearward end 24 of the left lift arm 11b via roller chain bolt 13d.

A fastener 14a affixes the leg 12a to the center plate 16; a fastener 14b affixes the leg 12b to the center plate 16; a fastener 14c affixes the leg 12c to the center plate 16; a fastener 14d affixes the leg 12d to the center plate 16. Before the fasteners 14a-14d are tightened to rigidly affix the legs 12a-12d to the center plate 16, the legs 12a-12d are each rotatable around their respective fastener 14a-14d. This rotation allows the legs 12a-12d to be adjusted so that they can be affixed to the lift arms 11a and 11b regardless of variations in the position of the lift arms 11a and 11b.

The center plate 16 comprises a rib bar 3 that extends upwardly between the pivot plates 17 of the legs 12a and 12b and the pivot plates 17 of the legs 12c and 12d, as shown. The rib bar 3 serves to prevent rotation of the center plate 116 during operation of the tractor. If the center plate 16 starts to rotate, the pivot plates 17 of the legs 12a-12d would contact the rib bar 3 and prevent the rotation. The center plate 16 thus serves to rigidify the lift arm stabilizer 10 during its operation.

The rib bar 3 is illustrated as extending across the center plate 16. However, in other embodiments, the rib bar 3 may comprise raised tabs (not shown) that protrude from the center plate 16. In this regard, any of a number of types of configurations of the center plate 16 may serve to prevent rotation of the center plate.

Further, other embodiments of the stabilizer 10 may not use a center plate 16 at all. Rather, in other embodiments the legs 12 may be coupled directly together via a fastener (not shown) or other means. Or, as shown in the illustrated embodiment, the legs 12 may be coupled together via the center plate 16.

In still other embodiments of the stabilizer, the legs 12 may not be angled as illustrated, but may be comprised of straight segments that extend downward from the lift arms 11 and then inward toward the center.

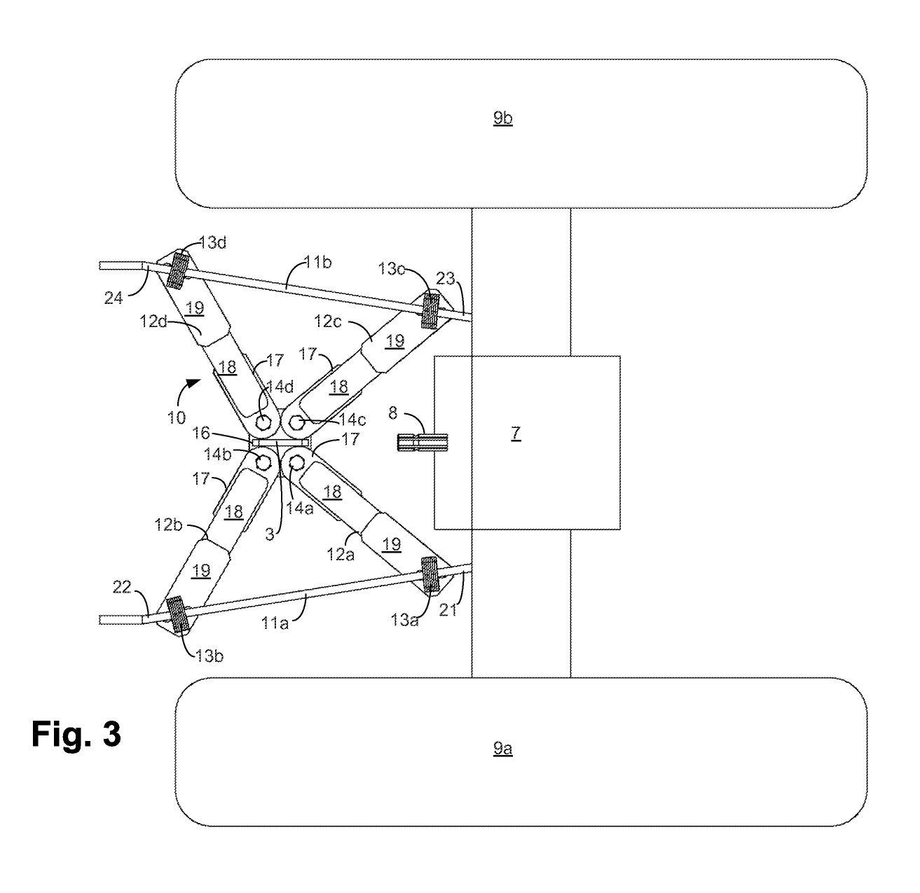

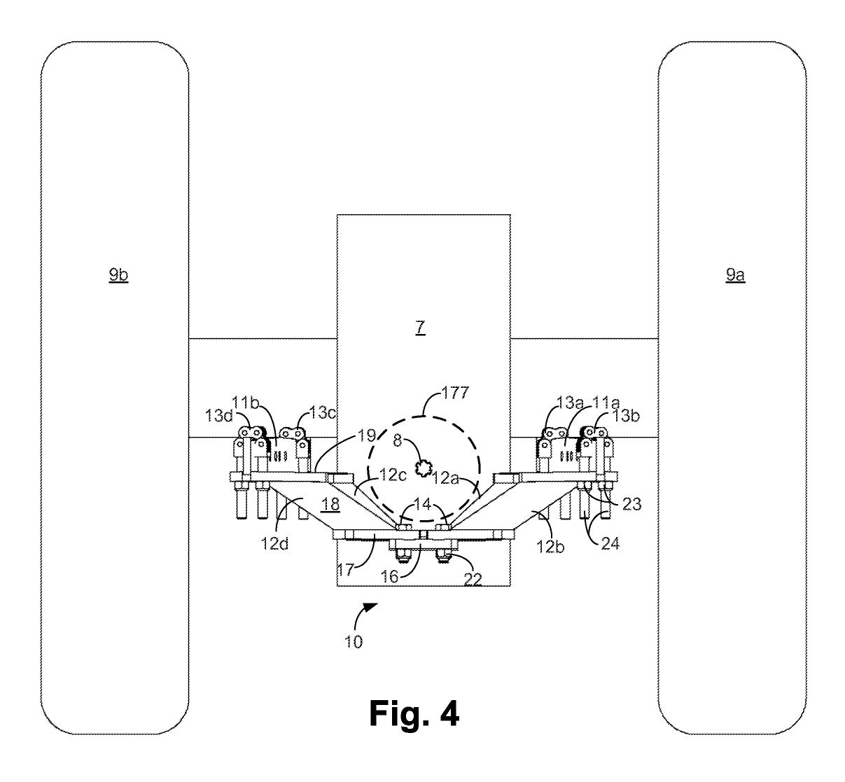

FIG. 4 is a rear plan view of the stabilizer 10 of FIG. 2. Note that the PTO 8 extends from the tractor 7 in general vertical alignment with the center plate 16 of the stabilizer 10. The center plate 16 is disposed beneath the PTO 8 (i.e., is at height lower than the PTO 8) and the legs 12a-12d angle downwardly, which keeps the general “footprint” around the PTO 8 clear for attachment to implements (not shown). The legs 12a-12d thus bound a clear space 177 through which an implement can be connected to the PTO 8.

The center plate 16 is affixed to the legs 12a-12d via the fasteners 14 and secured with bolts 22. The roller chain bolts 13a-13d affix the lift arms 11a and 11b to the legs 12a-12d. In this regard, the roller chain bolts 13a-13d each comprises an adjustable U-shaped body with threaded male ends 24 that pass through openings in the bolt plate 19. The roller chain bolts 13a-13d are secured to the bolt plates 19 via nuts 23.

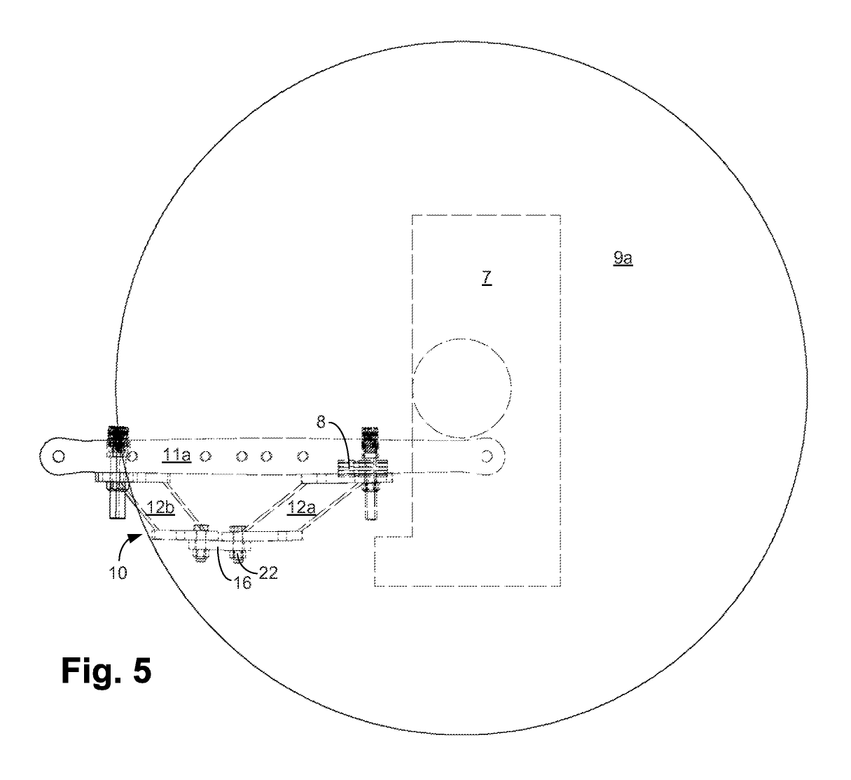

FIG. 5 is a side plan view of the stabilizer 10 of FIG. 2. Note that the lift arm 11a is in the same general horizontal plane as the PTO 8. This illustrates the need for the legs 12a-12d of the stabilizer 10 to extend below the PTO 8 in order to rigidify the lift arms 11a and 11b (FIG. 2). In the illustrated embodiment, the legs 12a-12d avoid the PTO 8 by extending below the PTO 8. In other embodiments, the legs 12a-12d may extend angularly above the PTO 8 and in the same manner rigidify the lift arms 11a and 11b without interfering with the PTO footprint.

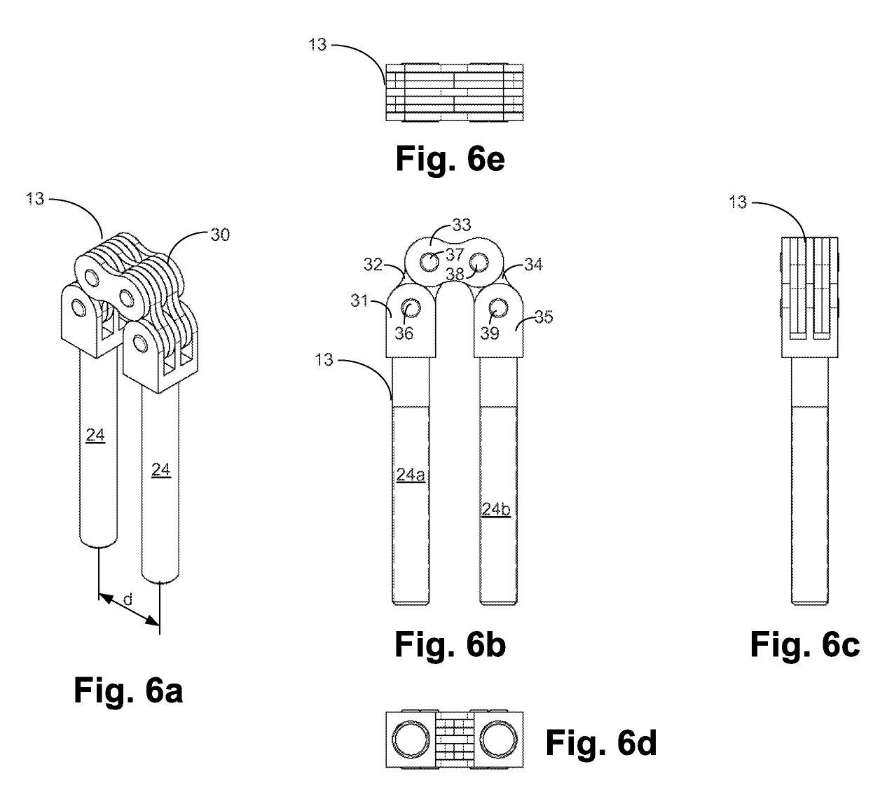

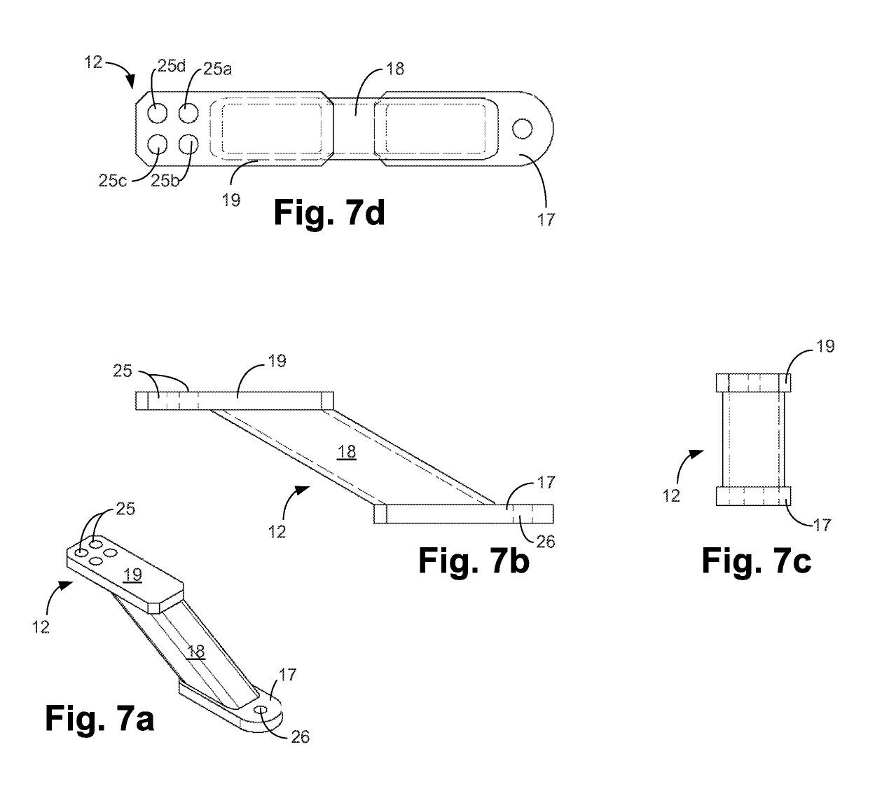

FIG. 6a is a perspective view of a roller chain bolt 13 according to an embodiment of the present invention. The roller chain bolt 13 comprises a generally U-shaped body with two (2) free bolt ends 24 that are threaded with male threads (not shown). A plurality of adjustable chain links 30 connects the two bolt ends 24 together. The chain links 30 allow the distance “d” between the bolt ends 24 to be adjusted. This adjustability permits the roller chain bolt 13 to be installed in different locations, as discussed below with respect to FIG. 7.

FIG. 6b is a front plan view of the roller chain bolt 13. In this embodiment, the chain links 30 (FIG. 6a) comprise five different chain “segments,” referenced as segments 31, 32, 33, 34 and 35. Segment 31 is rigidly affixed to bolt end 24a, and rotates about a pin 36 with respect to segment 32. Segment 32 extends between segment 31 and segment 33, and rotates about pin 36 with respect to segment 31 and about pin 37 with respect to segment 33. Segment 33 extends between segment 32 and segment 34, and rotates about pin 37 with respect to pin 32 and rotates about pin 38 with respect to segment 34. Segment 34 extends between segment 33 and 35 and rotates about pin 38 with respect to segment 33 and rotates about pin 39 with respect to segment 35. Segment 35 is rigidly affixed to bolt end 24b, and rotates about pin 39 with respect to segment 34.

FIGS. 6c-6e depict a side, bottom, and top view of the roller chain bolt 13, respectively. Although the illustrated embodiment of the roller chain bolt 13 utilizes chain links to provide an adjustable, U-shaped, double-ended bolt, other types and/or combinations of bolts, clamps, and fasteners may be used alternatively to attach the stabilizer 10 (FIG. 2) to the lift arms 11a and 11b (FIG. 2).

FIG. 7a is a perspective view of a leg 12 according to an embodiment of the disclosure. The leg 12 comprises a generally hollow tube 18 extending angularly between the lower pivot plate 17 and the upper bolt plate 19.

A plurality of openings 25 extend through the upper bolt plate 19 and receive the bolt ends 24 (FIG. 5a) of the roller chain bolt 13. An opening 26 extends through the lower pivot plate 17 and receives the fasteners 14 (FIG. 2) that attach the legs 12 to the center plate 16.

FIG. 7b is a side plan view of the leg 12 of FIG. 7a. The tube 18 extends downwardly at an angle of generally 30 degrees in the illustrated embodiment.

FIG. 7c is an end view of the leg 12 of FIG. 7a. The upper bolt plate 19 and the lower pivot plate 17 are generally parallel to one another, as shown.

FIG. 7d is a top view of the leg 12 showing four (4) openings 25a-25d in the upper bolt plate 19 for receiving the bolt ends 24a and 24b (FIG. 6b) of the roller chain bolt 13 (FIG. 6b). Although four (4) openings are shown in this embodiment, there may be more or fewer openings in other embodiments. The openings 25a-25d are arranged in a square as shown. This arrangement enables the bolt ends 24a and 24b (FIG. 6b) to be installed in the openings 25a-25d in a variety of ways, because the bolt ends 24a and 24b may be installed in any two of the four openings 25a-25d. For example, the bolt ends 24a and 24b may be installed in openings 25b and 25d, and the openings 25a and 25c may be left empty. Or, in an alternative example, the bolt ends 24a and 24b may be installed in openings 25a and 25c, and the openings 25b and 25d may be left empty. Or, in a further alternative example, the bolt ends 24a and 24b may be installed in openings 25a and 25b, and the openings 25c and 25d may be left empty. This configuration makes the legs 12 adaptable for a variety of different positions and angles of the lift arms 11a and 11b (FIG. 2).

Further, this configuration enables the legs 12 to be “generic” regardless of which position each leg is installed. For example, referring to FIG. 2, the angle of leg 12c with respect to leg 12d requires that different openings 25a-25d (FIG. 7d) be used for leg 12c than for leg 12d.

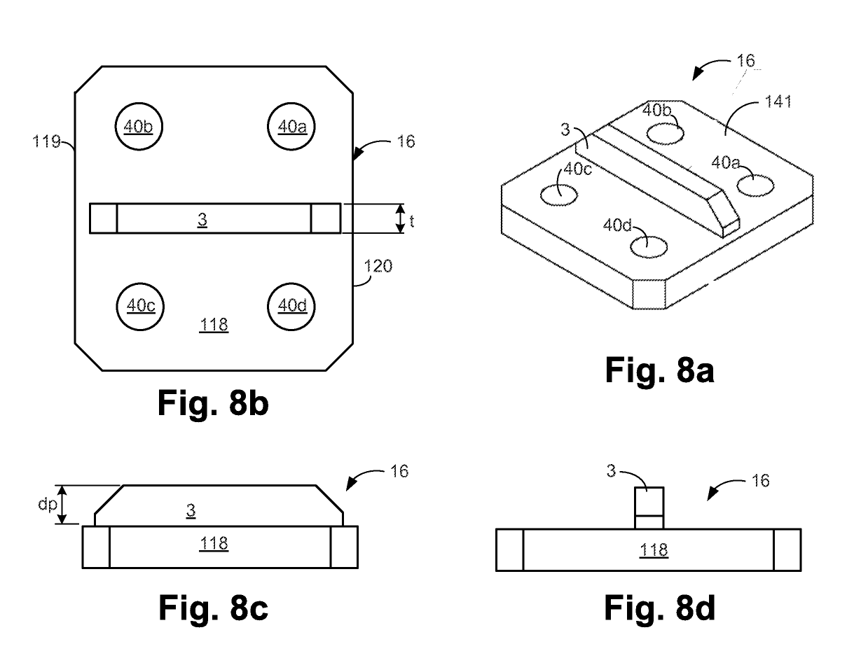

FIG. 8a is a top plan view of the center plate 16 according to an embodiment of the present disclosure. The center plate 16 comprises a generally rectangular flat plate 118 with chamfered corners and four (4) openings 40a-40d for receiving the fasteners 14 (FIG. 2) that affix the legs 12 (FIG. 2) to the stabilizer 10 (FIG. 2). A rib bar 3 extends across an upper surface 141 of the flat plate 118 and protrudes upwardly from the flat plate 118. In the illustrated embodiment, the rib bar 3 is affixed to the flat plate 118 by welding.

FIG. 8b is a top plan view of the center plate 116 of FIG. 8a. The rib bar 3 bisects the flat plate 118, extending from near a front edge 120 of the flat plate 118 to near a rear edge 119 of the flat plate 118. The rib bar 3 has a thickness “t” that is ½ inches in one embodiment.

FIG. 8c is a right side plan view of the center plate 116 of FIG. 8a. The rib bar 3 extends upwardly from the flat plate 118 a distance “dp” that is approximately ¾ inches in one embodiment.

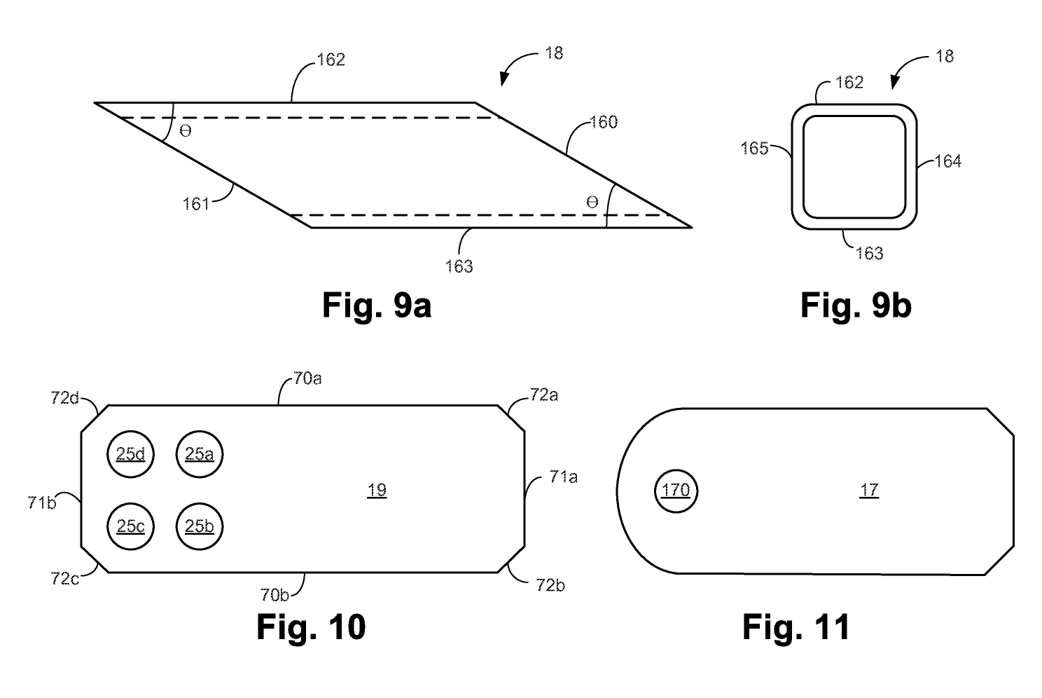

FIG. 9a is a side plan view of a tube 18 according to an embodiment of the present disclosure. In the embodiment depicted, the tube 18 is angled at each of its top and bottom ends 160 and 161 at an angle ⊖ with respect to sides 162 and 163 of the tube 18. In one embodiment the angle ⊖ is generally 30 degrees.

FIG. 9b is an end view of the tube 18 of FIG. 9a. In the illustrated embodiment, the tubes 18 are formed from hollow tubing with a generally rectangular cross section with adjacent sides 162, 164, 163, and 165 generally perpendicular to one another. The corners are rounded in the illustrated embodiment. In other embodiments, the tubes 18 may be comprised of solid bars or angle iron or the like, and may not be formed from hollow tubing.

FIG. 10 is a top plan view of a bolt plate 19 according to an embodiment of the present disclosure. The bolt plate 19 comprises opposed long sides 70a and 70b that are generally parallel to one another and opposed short sides 71a and 71b that are generally parallel to one another and generally perpendicular to the long sides 70a and 70b. Four corners 72a, 72b, 72c, and 72d are chamfered at generally 45 degrees in the illustrated embodiment.

The bolt plate 19 further comprises openings 25a-25d. The openings 25a-25d extend through the bolt plate 19 and receive the ends 24a and 24b (FIG. 6b) of the roller chain bolt 13 (FIG. 2).

FIG. 11 is a top plan view of a pivot plate 17 according to an embodiment of the present disclosure. The pivot plate 17 has an opening 170 on at one end for receiving the bolt 14 (FIG. 2).

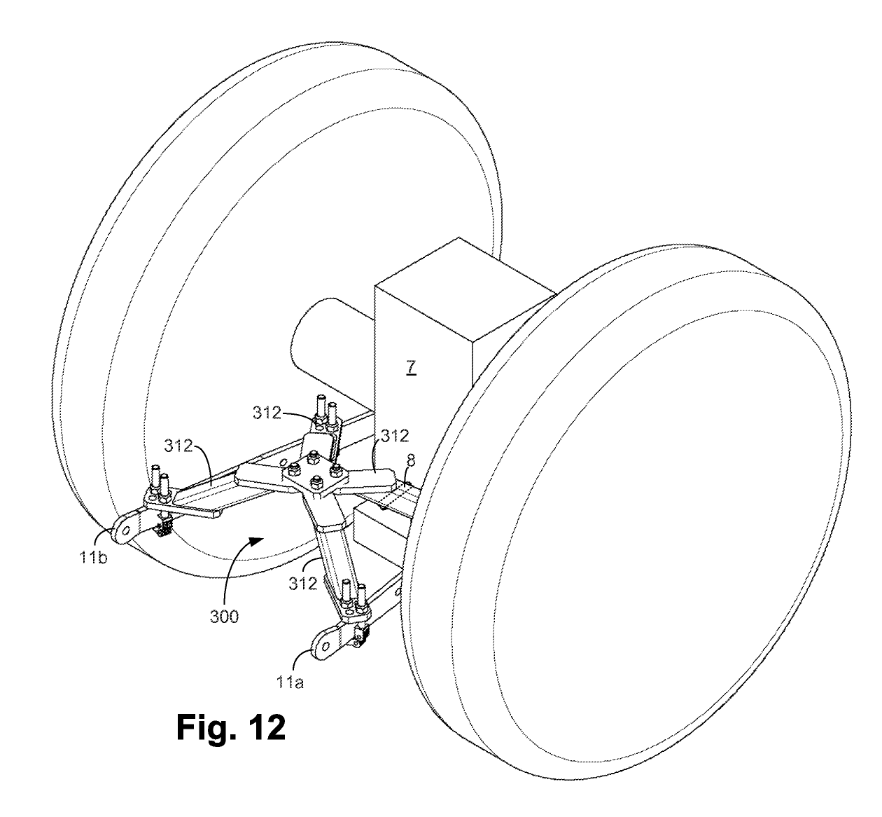

FIG. 12 is a rear perspective view of an alternative embodiment of an exemplary stabilizer 300 in accordance with the present disclosure installed on the lift arms 11a and 11b of the tractor 7. In this embodiment angled legs 312 are adjustably affixed to and extend upwardly from the lift arms 11a and 11b. The angled legs 312 thus differ from the angled legs 12 of FIG. 2 above, in that the legs 312 extend above the PTO 8 instead of below the PTO at as in FIG. 2. In all other respects, the angled legs 312 are substantially similar to the legs 12 of FIG. 2.

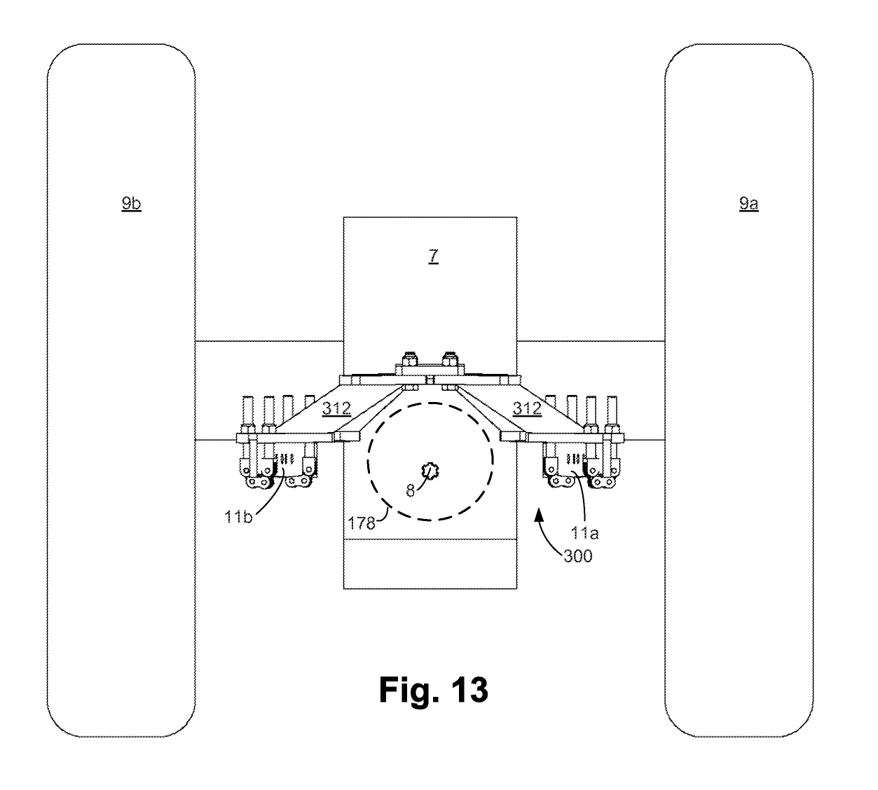

FIG. 13 is a rear plan view of the stabilizer 300 of FIG. 12. The legs 312 extending upwardly from the lift arms 11a and 11b forms a space 178, or footprint, around the PTO 8 through which an implement (not shown) can be connected to the PTO 8.

FIG. 14 depicts a stabilizer 410 according to an alternative embodiment of the present disclosure. The stabilizer 410 is installed on the tractor 7 to stabilize the lift arms 11a and 11b. In this regard, the stabilizer 410 extends between the lift arms 11a and 11b of the tractor 7 without interfering with a drive line 488 that extends from the PTO 8, by passing beneath the drive line 488 and PTO.

The stabilizer 410 comprises two angled legs, a first angled leg 412a and a second angled leg 412b, which angle downwardly and toward each other and terminate at a center portion 416. At their upper ends, the angled legs 412a and 412b terminate at an upper bolt plate 419a and 419b, respectively. In the illustrated embodiment, the legs 412a and 412b and the center portion 416 each comprise hollow metal tubing with a generally rectangular cross section. The center portion 416 extends between and is welded to the legs 412a and 412b.

The upper bolt plates 419a and 419b of the legs 412a and 412b connect to the lift arms 11a and 11b via a plurality of roller chain bolts 13. In one embodiment, the roller chain bolts 13 each comprise a plurality of free-moving links held moveably in position by connectors, as further discussed herein. Thus, there is some give between the links such that the roller chain bolts 13 do not rigidly retain the lift arms 11a and 11b and can be adjustably connected to the upper bolt plates 419a and 419b around the lift arms 11a and 11b.

The roller chain bolts 13 are received by openings (not shown) in the upper bolt plates 419a and 419b and are secured by nuts (not shown). The roller chain bolts 13 therefore comprise male threads (not shown) to receive the nuts.

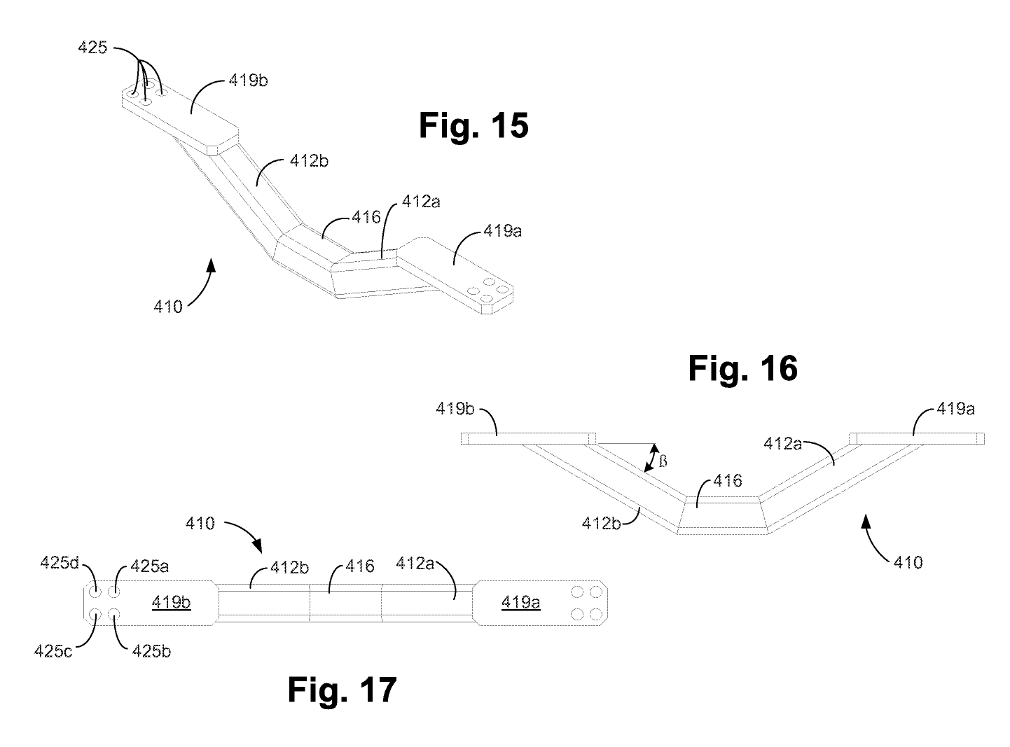

FIG. 15 is a perspective view of the stabilizer 410 of FIG. 14, shown removed from the tractor 7 (FIG. 14). The upper bolt plates 419a and 419b each comprise elongated plates with four (4) openings extending therethrough. The openings (4) receive the roller chain bolts 14 (FIG. 14), as further discussed herein. In the illustrated embodiment, the upper bolt plates 419a and 419b are affixed to the angled legs 412a and 412b, respectively, by welding.

FIG. 16 is a rear plan view of the stabilizer 410 of FIG. 14, shown removed from the tractor 7 (FIG. 14). The upper bolt plates 419a and 419b each comprise generally flat upper surfaces that are coplanar as shown. The legs 412a and 412b angle downwardly from the upper bolt plates 419a and 419b at an angle β, which is generally 30 degrees in one embodiment.

FIG. 17 is a top view of the stabilizer 410 of FIG. 14, shown removed from the tractor 7 (FIG. 14). The upper bolt plates 419a and 419b are substantially similar to the upper bolt plate 19 shown in FIG. 10 and discussed herein.

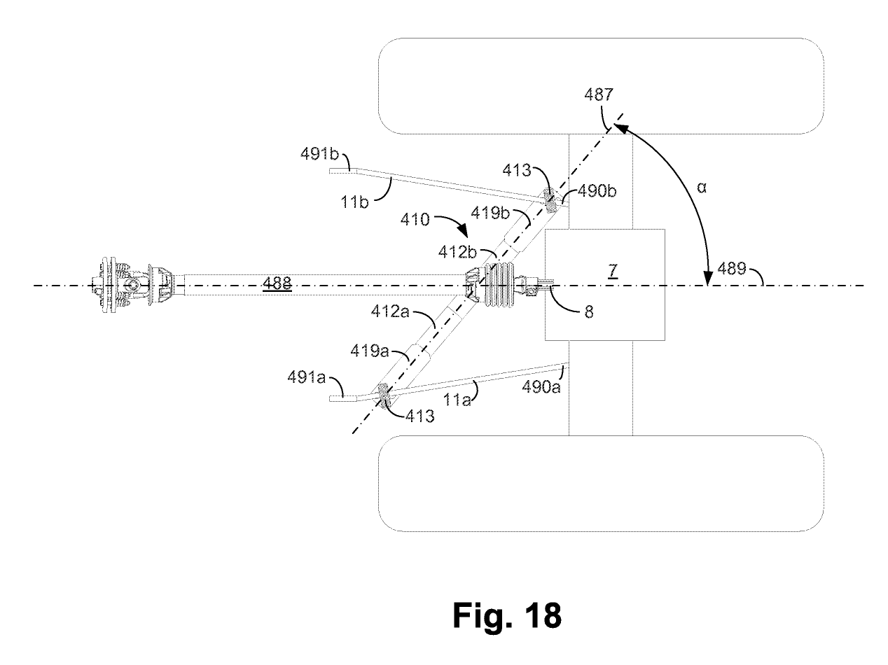

FIG. 18 is a top view of the stabilizer 410 of FIG. 14 shown installed on the tractor 7. The lift arms 11a and 11b extend rearwardly and angularly from the tractor 7. The upper bolt plate 419a couples with the lift arm 11a near a rearward end 491a of the lift arm 11a as shown. The upper bolt plate 419b couples with the lift arm 11b near a forward end 490b of the lift arm 11b as shown. The stabilizer 410 is thus diagonally disposed with respect to a center axis 489 extending longitudinally down the tractor 7, forming an angle α with respect to the center axis 489. In one embodiment, the angle α is generally 45 degrees. (Note that reference number 487 is used to designate a centerline of the stabilizer 410).

Regardless of the precise angle α used, an object of this embodiment in order for the stabilizer 410 to provide the maximum amount of stiffness to the lift arms 11a and 11b is for the stabilizer 410 to be connected as rearward as possible to one lift arm 11a or 11b and as forward as possible to the other lift arm 11a or 11b. In other words, if the stabilizer 410 were connected such that α is 90 degrees, the stiffness would be lessened, and the stabilizer 410 less effective. In an alternative—but equally effective—configuration to the illustrated embodiment, the stabilizer 410 could be connected with the upper bolt plate 419b coupled near a rearward end 491b of the lift arm 11b and the upper bolt plate 419a coupled near a forward end 490a of the lift arm 11a.

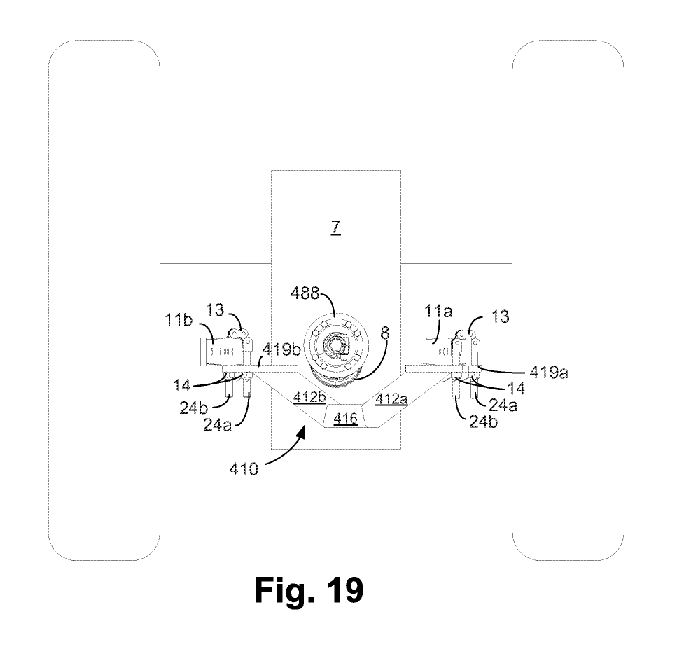

FIG. 19 is a rear view of the stabilizer 410 of FIG. 14. The drive line 488 extends rearwardly from the power take-off of the tractor 7. The stabilizer extends from the lift arm 11a underneath the drive line 488 (and power take-off 8) to the lift arm 11b. The upper bolt plate 419a couples to the lift arm 11a via the roller chain bolt 13. Bolt ends 24a and 24b of the roller chain bolt 13 extend through openings (not shown) on the upper bolt plate 419a and are secured via fasteners 14. The angled leg 412a extends from the upper bolt plate 419a a downwardly and angularly to the center portion 416, which is disposed beneath the drive line 488 (and power take-off 8). The upper bolt plate 419b couples to the lift arm 11b via the roller chain bolt 13. Bolt ends 24a and 24b of the roller chain bolt 13 extend through openings (not shown) on the upper bolt plate 419b and are secured via fasteners 14. The angled leg 412b extends from the upper bolt plate 419b a downwardly and angularly to the center portion 416.

In the illustrated embodiment, the angled legs 412a and 412b and the center portion 416 are shown and described as three pieces of metal that are welded together. In other embodiments, these pieces may be formed from one solid metal piece, such that no welding is necessary. Alternatively, the angled leg 412a may extend all the way to the angled leg 412b and be welded directly to the leg 412b (in a “V” shape, for example) with no center portion 416.

Further, in other embodiments, the stabilizer 410 may be installed on top of the lift arms 11a and 11b such that the stabilizer 410 extends above the drive line 488 (and is thus above the power take-off 8), instead of below.

1. An apparatus, comprising:
a first angled leg releasably affixed to a first lift arm of a tractor at a first location along the first lift arm, the first angled leg comprising an upper end and a lower end, the lower end disposed downwardly and angularly from the upper end;
a second angled leg releasably affixed to a second lift arm of a tractor at a second location along the second lift arm, the second location rearwardly disposed with respect to the first location, the second angled leg comprising an upper end and a lower end, the lower end disposed downwardly and angularly from the upper end;
the first angled leg coupled to the second angled leg below a drive line of the tractor.

2. The apparatus of claim 1, wherein each angled leg comprises an upper bolt plate connected to the upper end.

3. The apparatus of claim 2, wherein each upper bolt plate comprises at least two openings.

4. The apparatus of claim 3, further comprising a plurality of connectors that extend around the periphery of the lift arms and connect to the at least two openings.

5. The apparatus of claim 4, wherein the connectors are roller chain bolts.

6. The apparatus of claim 2, wherein each upper bolt plate comprises four openings.

7. The apparatus of claim 6, further wherein each angled leg comprises a connector that extends around the periphery of the lift arm and connects to at least two of the four openings.

8. The apparatus of claim 1, wherein the first angled leg is coupled to the second angled leg via a center portion, the center portion welded to and extending between the first angled leg and the second angled leg.

9. The apparatus of claim 1, wherein the angled legs form a space through which an implement can be connected to the power take-off of the tractor.

10. An apparatus comprising:
a first leg comprising a first upper surface, the first upper surface coupled a first lift arm of a tractor, the first leg extending downwardly and angularly from the first lift arm to which it is coupled;
a second leg comprising a second upper surface, the second upper surface coupled to a second lift arm of a tractor, the second leg extending downwardly and angularly from the second lift arm to which it is coupled, the first leg and the second leg each welded to a center portion that extends between and joins the first leg and the second leg, the center portion disposed below a drive line of the tractor.

11. The apparatus of claim 10, wherein the upper surfaces of the first leg and the second leg each comprise at least two openings.

12. The apparatus of claim 11, wherein the first and second lift arms are connected to the first and second upper surfaces by a u-shaped connector that extends about the lift arms and that couples to the at least two openings.

13. The apparatus of claim 10, wherein the first leg is coupled to the first lift arm at a first location along the first lift arm, and the second leg is coupled to the second lift arm at a second location along the second lift arm, the second location disposed rearwardly from the first location in relation to the tractor.

14. An apparatus, comprising:
a first angled leg releasably affixed to a first lift arm of a tractor, the first angled leg comprising a first end and a second end, the second end disposed upwardly and angularly from the first end;
a second angled leg releasably affixed to a second lift arm of a tractor, the second angled leg comprising a first end and a second end, the second end disposed upwardly and angularly from the first end;
the first and second legs rigidly affixed together to form a stabilizer, the stabilizer oriented diagonally with respect to a center longitudinal axis of the tractor, the stabilizer disposed beneath the drive line of the tractor.

15. The apparatus of claim 14, wherein the first leg is coupled to the first lift arm at a first location along the first lift arm, and the second leg is coupled to the second lift arm at a second location along the second lift arm, the second location disposed rearwardly from the first location in relation to the tractor.
